(19) United States
(12) Patent Application Publication
(10) Pub. No.: US 2016/0299557 A1
(43) Pub. Date: Oct. 13, 2016

(54) Automatic Activating System for Computer Manual Power Control Switch

(71) Applicant: Control Module, Inc., Enfield, CT (US)

(72) Inventors: James S. Bianco, Suffield, CT (US); John Fahy, Longmeadow, MA (US); David C. Parmelee, East Hartland, CT (US)

(21) Appl. No.: 15/091,707

(22) Filed: Apr. 6, 2016

Related U.S. Application Data
(60) Provisional application No. 62/144,049, filed on Apr. 7, 2015.

(51) Int. Cl. G06F 1/32; G06F 13/42

(52) U.S. Cl. CPC G06F 1/3287; G06F 13/4282; G06F 1/3212; G06F 1/3296

(57) ABSTRACT

A system involves the use of a power sensing circuit and an actuating module to automatically press the power control button on a portable computer used as a fixed work station when primary power is applied. The actuator module preferably employs a solenoid which controls the displacement of an actuating arm to selectively depress the power control button.

### CROSS-REFERENCE TO RELATED APPLICATION

This application claims the priority of U.S. Provisional Patent Application No. 62/144,049 filed on Apr. 7, 2015, the disclosure of which is incorporated by reference in its entirety.

### BACKGROUND

It is highly desirable to use portable computers, such as laptops and tablets, because of their low cost and battery operation at fixed locations such as workstations and time clocks to name a few. As a work station or time clock, it is desirable to continuously keep the computer operational and not require the user to turn on the power, to use the station. One of the problems of using portable computers is that their power switch, by design, is located within easy reach for the user. This exposed power switch is subjected to unauthorized turning off the computer, causing operational delays and possible loss of data. To prevent this, the portable computer is enclosed in a tamper proof enclosure. However, enclosing the power switch creates a problem when it is desirable to turn the computer on and off by authorized personnel.

This disclosure relates to automatically pressing the power button, on the portable computer, when power is initially applied or after a primary power outage, caused the computers batteries to deplete, and shut down.

A limited access tab allows authorized personnel to turn on and off the power to the computer without disassembling the computer tamper proof enclosure.

### SUMMARY

An automatic power activator, which is mechanically attached to the portable computer, when activated by a power control module, will press the power control button on the portable computer. The power control module monitors the primary power sources and the operational status of the portable computer. When primary power is applied to the power control module and the portable computer is in the off mode, a voltage pulse is sent from the power control circuit to the solenoid actuator, causing it to move the actuator arm in such a manner as to press the power control button on the portable computer. This action causes the portable computer to turn on.

An automatic activating system for a manual power control switch for a computer comprises a power control module and an actuator module. The power control module comprises a microprocessor which selectively generates a signal in response to the status of the power control switch and at least one power input. The actuator module comprises a displaceable actuator arm selectively engageable against a button for the power control switch and responsive to said signal for controlling the status of the switch.

The actuator module is mounted at an underside of the computer and, in one embodiment, is secured to the underside by double-sided tape. In one embodiment, the actuator module further comprises a solenoid for controlling the position of the actuator arm. The signal comprises a voltage pulse.

In one embodiment, when the microprocessor senses a primary voltage input, a USB power input at a USB connector to the computer is checked. When there is no voltage at the USB connector, a voltage pulse is transmitted to a solenoid operatively connecting the actuator arm. When the microprocessor senses a primary voltage input at the USB connector, no voltage pulse is transmitted to the solenoid for the actuator arm. The computer has a battery power supply and the power control module controls said actuator module so that the computer power switch is on when the battery power supply powers the computer and the computer is not supplied power from an external source.

An automatic power control activating system comprises a computer with a power control switch having an exteriorly manually activatable button. An actuator module comprises a bracket mounting a solenoid operatively connected to a displaceable actuator arm. The actuator arm selectively engages against the button. The solenoid is responsive to a signal for controlling the status of the switch by controlling the position of the actuator arm. A power control module comprises a microprocessor which selectively generates the signal in response to the status of the power control switch. The actuator module is mounted at an underside of the computer. The signal comprises a voltage pulse. In some operational modes, the battery power supply of the computer supplies the power for the computer. The actuator arm is positionable so that the power switch is on when the battery power supply powers the computer and the computer is not supplied power from an external source.

An automatic power control activating system comprises a computer having an internal power supply and a power control switch with an externally depressible button transformable between an off status and an on status. A power control module, which selectively generates an operational signal in response to the status of the power control switch and at least one input. An actuator module comprising a displaceable actuator arm selectively engages against the button and is responsive to the operational signal for controlling the status of the power control switch. The actuator module is preferably positioned at an underside of the computer. The depression of the power control switch button changes the power control on/off status to an opposite status. The power control module senses power supplied to the computer from an exterior power source or power supplied over the internet. In one embodiment, the automatic power control activating system comprises a power control module which senses a computer output which may be either a USB voltage or an audio jack voltage.

### BRIEF DESCRIPTION OF THE DRAWINGS

FIG. 1 is an isometric view, partly in phantom, of a power switch actuator module, attached to the underside of a portable computer and connected to a power control module;

FIG. 2 is a cutaway side view, partly in phantom, of the enclosure housing the portable computer with the power switch and actuator module attached to the underside of the portable computer and the actuator module plugged into the control module with its input and output connectors;

FIG. 3 is an isometric view of the power switch actuator module;

FIG. 4 is an isometric exploded view of the power switch actuator module components;

FIG. 5 is an annotated block diagram of the power control module, portable computer and the power switch actuator module;

FIG. 6 is an annotated timing diagram of the power control system; and

FIG. 7 is a flowchart for the operation of the automatic activating system.

### DETAILED DESCRIPTION

With reference to the drawings wherein like numerals represent like parts throughout the several figures, a system for automatically activating a power control switch of a computer comprises an actuator control module and is generally designated by the numeral 10.

The present invention may be employed, for example, with different power switch actuator modules, muscle wire, motor driven or other cam driven methods, although the operation of the invention is described with reference to a solenoid driven actuator arm.

The drawing figures illustrate a power sensor module, generally indicated by the reference 100 and a power actuator generally indicated by reference 200. Both components may be constructed according to the present disclosure.

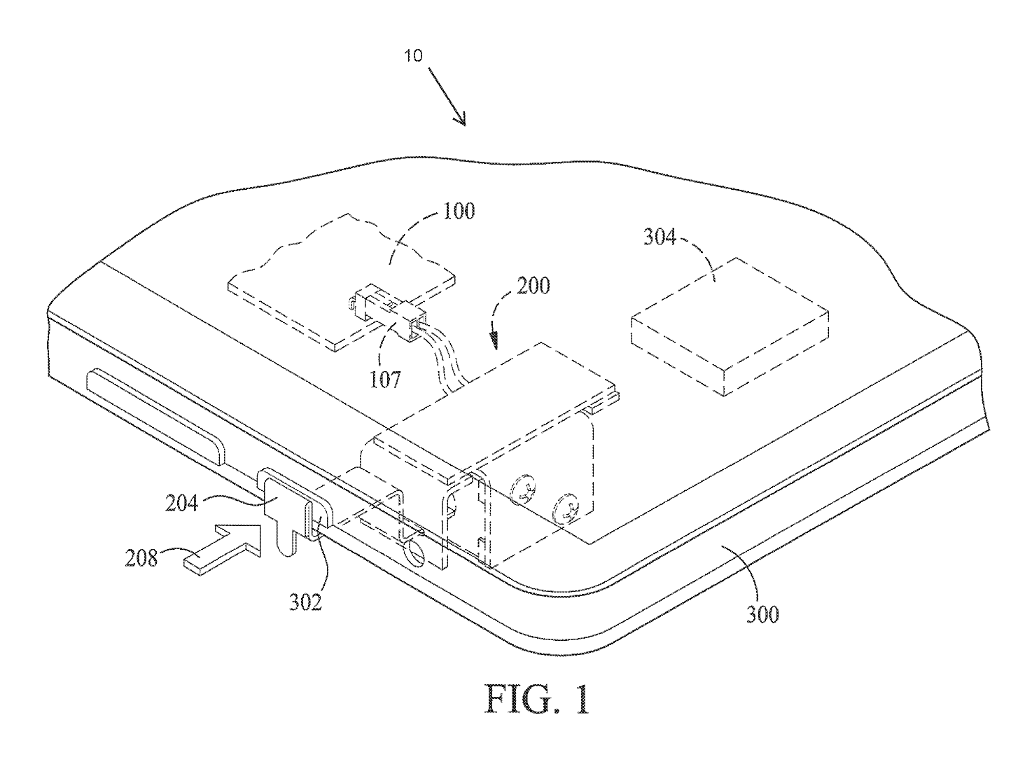

FIG. 1 illustrates the power switch actuator module 200 mechanically attached to the base of the portable computer (tablet) 300 such that the actuator arm 204 is positioned directly in front of and slightly touching the portable computer power control button 302. When the power switch actuator module 200 is energized, it will move in the direction shown as 208 such that it will press on the portable computer power control button 302, activating the portable computer 300. The actuator control module 100, which may or may not be attached to the portable computer 300, is shown for reference only. The portable computer internal battery 304 is also shown for reference only.

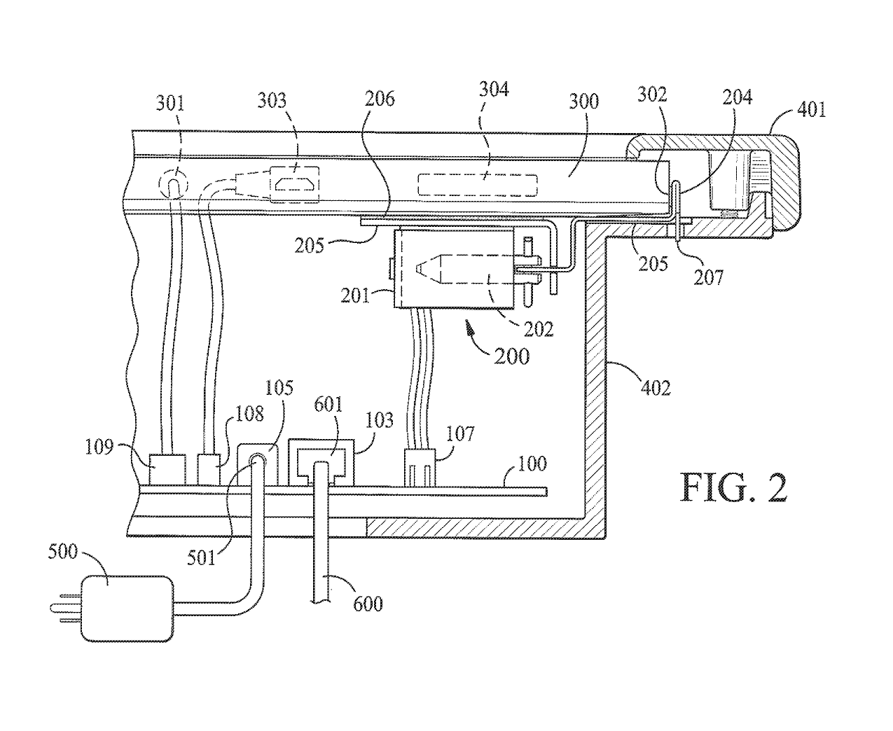

FIG. 2 illustrates a cutaway side view of a representative enclosure 400 as described in U.S. Pat. No. D697,910 issued Jan. 21, 2014 to James S Bianco et al, and titled Touch Screen Terminal for Time and Attendance Systems, with bezel 401 and the enclosure base 402 housing the portable computer 300. The power switch actuator module 200 is attached to the underside of the portable computer 300 with a double sided tape 206. The activator solenoid 201 is plugged in to the actuator control module 100 with its power connector 107. The actuator arm 205 is attached to the actuator plunger 202, using the actuator attachment pin 203. The portable computer power input connector 301 is connected to portable computer 300 and the actuator control module 100 with the power output connector 109. The portable computer USB connector 303 is connected to portable computer 300 and the power control module 100 with the USB connector 108. Additionally, the AC to DC power module 500 output connector 501 and the Ethernet 600 connector 601 are plugged into the power input connector 105 and the network input connector 103 on the actuator control card 100, respectively.

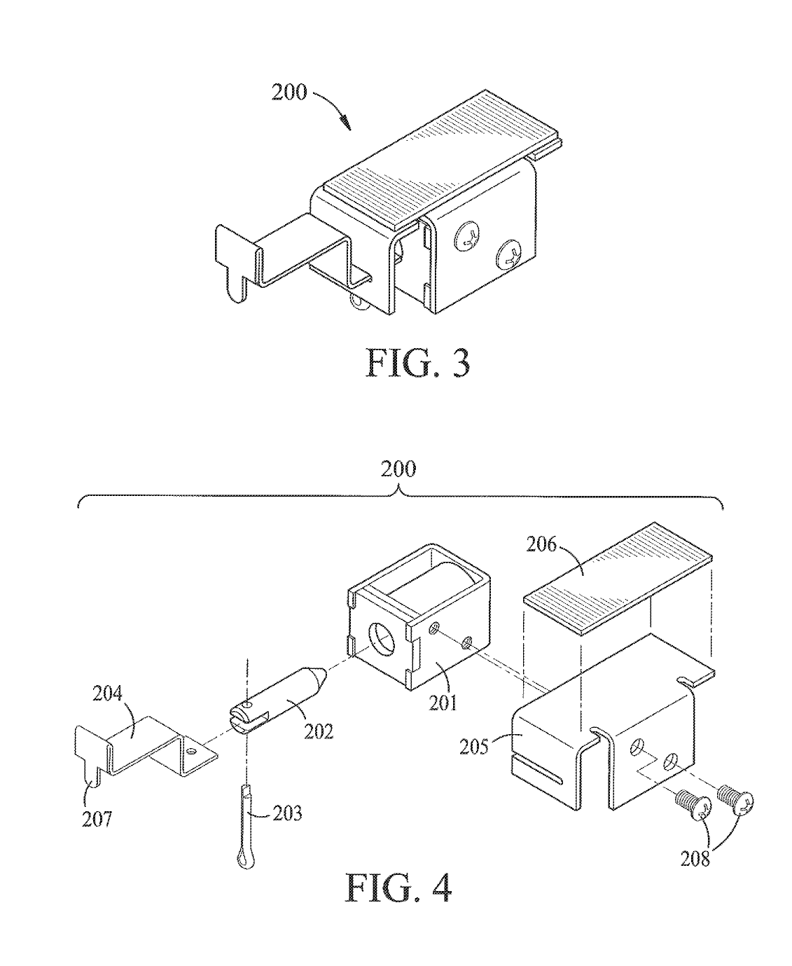

FIG. 3 illustrates the power switch actuator module assembly 200. FIG. 4 illustrates the power switch actuator module 200 prior to assembly of the components. The actuator arm 204 is attached to the actuator plunger 202 secured by the actuator pin 203, and the assembly is inserted into the actuator solenoid 201 attached to the actuator mounting bracket 204 with solenoid mounting screws 208. Double sided actuator mounting tape 206 is applied to the top of the mounting bracket 205.

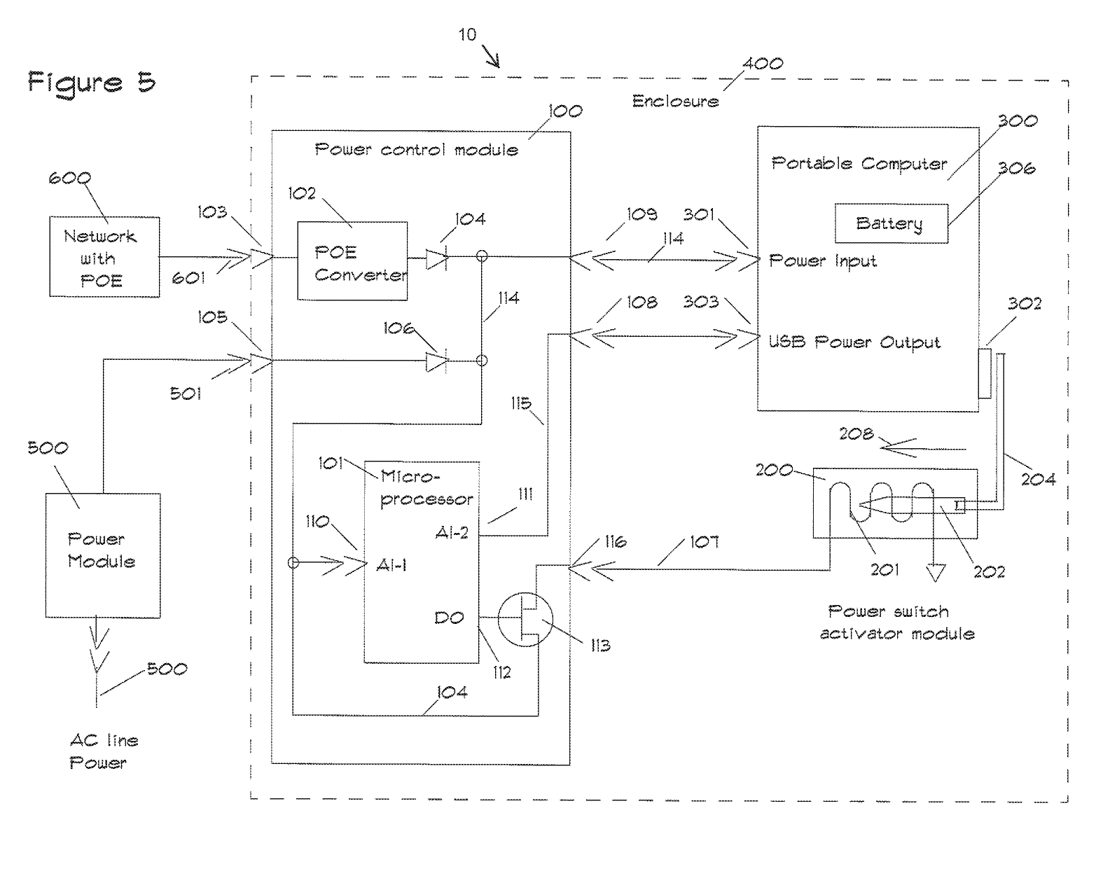

FIG. 5 Is a block diagram, of the system required for automatically pressing the power control push button 302 to activate computer 300, when primary power is supplied from either the network 600 or the power module 500 to the computer network input connection 103 or the power input connection 105, respectively. When network power 600 is applied to the network input connector 103, it is converted by POE converter 102 to a compatible voltage level 114 for computer 300 and applied via the Ethernet power diode 104 to the power input 301. When AC line power 502 is applied to the power module 500 at input 502, it is converted to a compatible voltage level 114 for computer 300 and applied via the power module diode 106 to the power input 301. The voltage 114 is also applied to the microprocessor 101 analogue input 110 and the FET power transistor 113.

When the microprocessor 101 senses a primary voltage input 110, the microprocessor 101 checks the USB power input 111. When there is no voltage present at the computer USB connector 303 (indicating that the computer 300 has been turned off), the microprocessor will generate a voltage pulse on its solenoid output 112. This, in turn, will turn on the FET power transistor 113. When the power transistor 113 turns on, it will provide a voltage pulse to the actuator solenoid 201, which will cause the actuator plunger 202 to be drawn into the solenoid 201. This motion 208 will apply a force on the portable computer 300 power control button 302, turning on the portable computer 300. When there is voltage present at the USB power sense input 111 (indicating that the computer 300 has been turned on), the microprocessor will not generate a voltage pulse on its solenoid output 112. This is because a pulse by the actuator 200 to the computer power control button 302 while the computer 300 is on, would turn off the computer 300.

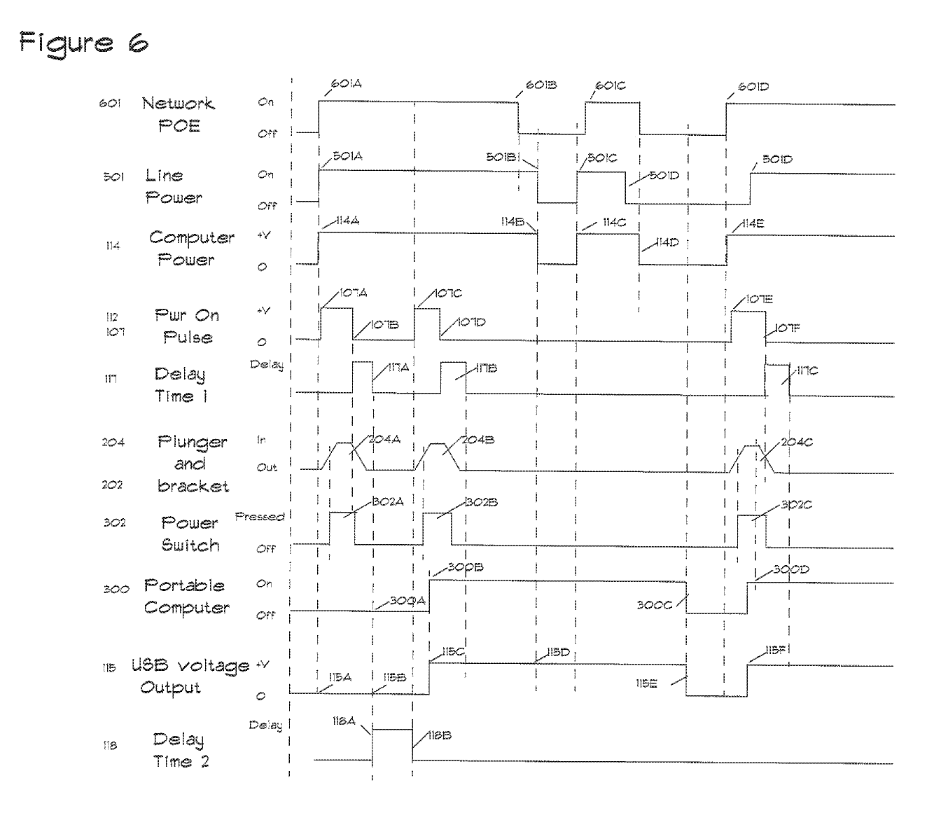

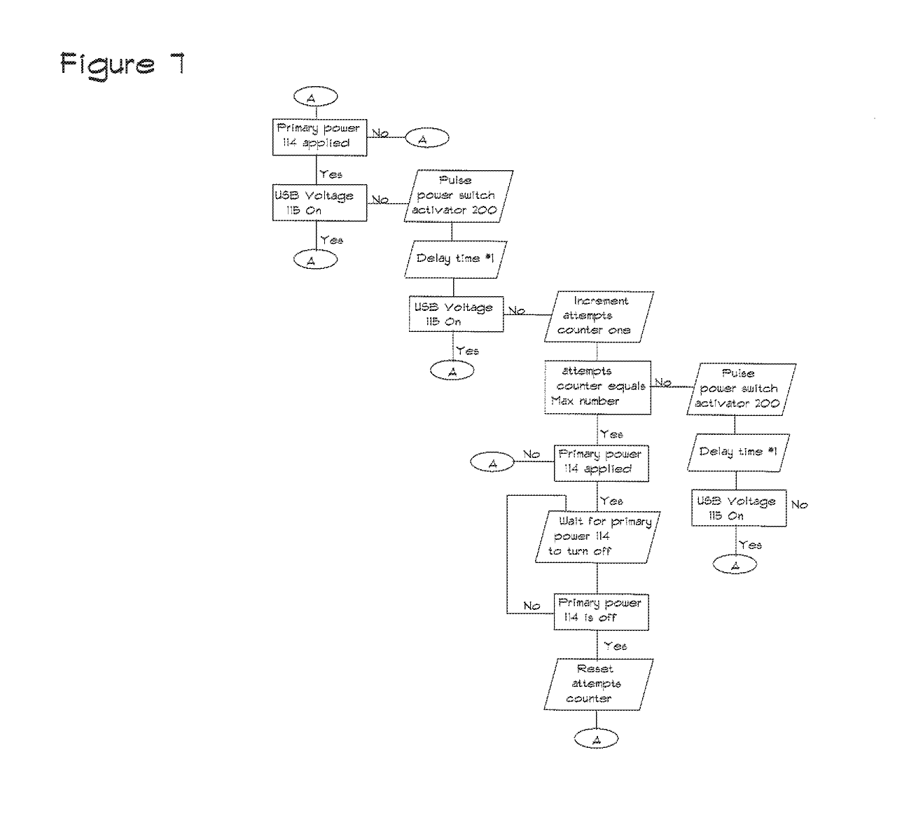

FIG. 6 is a timing diagram of the system required for automatically pressing the power control push button 302 to activate computer 300, when primary power is supplied, from either the network 600, or the power module 500, to the computer network input connection 103, or the power input connection 105, respectively. The timing diagram shows the relationship between primary input voltages 103A and/or 105A and the pressing of the computer power control button 302A.

When primary voltage is first applied to either the network input connector 103A or the power module input connector 105A, a voltage is supplied to the portable computer power input connector 301A, and the microprocessor primary power sense input 110A. The microprocessor 101 will recognize that primary power 114 has been supplied to the computer 300. The microprocessor 101 will then test to see if there is a voltage 115A on the USB power sense input 111. If there is no voltage 115A on the USB power sense input 111, the microprocessor 101 will generate a voltage pulse on its digital output 112, which, in turn, will turn on the FET transistor 113 sending a voltage pulse 107A to the power switch actuator module coil 201.

When the power switch actuator coil 201 is energized, it will cause the actuator plunger 202 and actuator arm 204A, attached to the actuator plunger 202, to be drawn into the actuator coil 201 in the direction 208. This motion will cause the activator arm 204A to momentarily press the power switch 302A, which in turn should cause the computer 300 to become active. After a short delay 117A, the microprocessor 101 will again test to see if there is a voltage 115B on the USB power sense input 111. If there is no voltage 115B on the USB power sensing input 111, then the microprocessor 101, after delay time 2 118B, will again generate a second power on pulse 107C. After a fixed number of failed attempts to turn on computer 300, the power is removed from the power control module 100 and reapplied to start the sequence again. However, when the computer 300 turns on supplying the USB voltage output 115C, the power on sequence will stop.

When both network power 601 B and line power 501 B are lost and the computer power 114B is not available, but the computer 300 continues to receive power from its internal battery 304, the USB voltage output 115D will also remain on until the internal battery 304 is depleted in the computer 300 and turns off. Should the line power 501 B or the network power 601 C be restored before the computer 300 internal battery is depleted, then no power on sequence will take place because pressing the power on button 302 would cause the computer 300 to turn off.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

1. An automatic activating system for a computer manual power control switch for a computer comprising:
a power control module comprising a microprocessor which selectively generates a signal in response to the status of the power control switch and at least one power input; and
an actuator module comprising a displaceable actuator arm selectively engageable against a button for said power control switch and responsive to said signal for controlling the status of said switch.

2. The automatic activating system of claim 1 wherein said actuator module is mounted at an underside of said computer.

3. The automatic activating system of claim 2 wherein said activator module is secured to said underside by double sided tape.

4. The automatic activating system of claim 1 wherein said activator module further comprises a solenoid which controls the position of said actuator arm.

5. The automatic activating system of claim 1 wherein said signal comprises a voltage pulse.

6. The automatic activating system of claim 1 wherein when said microprocessor senses a primary voltage input, a USB power input at a USB connector to said computer is checked.

7. The automatic activating system of claim 6 wherein when there is no voltage at the USB connector, a voltage pulse is transmitted to a solenoid for said actuator.

8. The automatic activating system of claim 6 wherein when said microprocessor senses a primary voltage input at the USB connector, no voltage pulse is transmitted to a solenoid for said actuator.

9. The automatic activating system of claim 1 wherein said power control module monitors line power to said computer and selectively actuates said actuator to turn off said computer arm.

10. The automatic activating system of claim 1 wherein said computer has an internal battery power supply and said power control module controls said actuator module so that said computer power switch is on when said battery power supply powers said computer while said computer is not supplied power from an external source.

11. An automatic power control activating system comprising:
a computer with a power control switch having an exteriorly manually activatable button; and
an actuator module comprising a bracket mounting a solenoid operatively connected to a displaceable actuator arm selectively engageable against said button, said solenoid being responsive to an operational signal for controlling the status of said switch by controlling the position of said actuator arm.

12. The automatic activating power control system of claim 11 further comprising a power control module comprising a microprocessor which selectively generates said operational signal in response to the status of the power control switch.

13. The automatic activating power control system of claim 11 wherein said actuator module is mounted at an underside of said computer in close proximity to said button.

14. The automatic activating power control system of claim 11 wherein said operational signal comprises a voltage pulse.

15. The automatic activating power control system of claim 11 wherein said computer has an operational battery power supply and said actuator arm is positionable so that the said power switch is on when the battery power supply powers the computer while the computer is not supplied power from an external source.

16. An automatic activating power control system comprising:
a computer having a power control switch transformable between an off status and an on status with an externally depressible button and an internal battery power supply;
a power control module which selectively generates a signal in response to the status of the power control switch and at least one input; and
an actuator module comprising a displaceable actuator arm selectively engageable against said button and responsive to said signal for controlling the status of said power control switch.

17. The automatic activating power control system of claim 16 wherein said actuator module is disposed at an underside of said computer.

18. The automatic power control activating system of claim 16 wherein depression of said power control switch changes said power control on/off status to an opposite status.

19. The automatic power control activating system of claim 16 wherein said power control module senses whether power is supplied to the computer from an exterior power source or power supplied over the internet.

20. The automatic power control activating system of claim 16 wherein said power control module senses a computer output selected from the group consisting of a USB voltage and an audio jack voltage.
